(19) United States
(12) Patent Application Publication
(10) Pub. No.: US 2024/0258094 A1
(43) Pub. Date: Aug. 1, 2024

(54) EXCIMER LAMP

(71) Applicant: Excelitas Technologies Corp., Waltham, MA (US)

(72) Inventor: Rudi Blondia, Stockton, CA (US)

(73) Assignee: Excelitas Technologies Corp., Waltham, MA (US)

(21) Appl. No.: 18/632,082

(22) Filed: Apr. 10, 2024

Related U.S. Application Data
(63) Continuation of application No. PCT/US23/83819, filed on Dec. 13, 2023.
(60) Provisional application No. 63/387,410, filed on Dec. 14, 2022.
(60) Provisional application No. 63/505,754, filed on Jun. 2, 2023.

(51) Int. Cl. H01J 61/54; H01J 61/35; H01J 65/04

(52) U.S. Cl. CPC H01J 61/54; H01J 61/35; H01J 65/046

(57) ABSTRACT

The techniques described herein relate to excimer lamps. An example excimer lamp includes a dielectric forming at least one side of a sealed cavity, an electrode array disposed over a surface of the dielectric, the electrode array comprising a plurality of electrodes of alternating polarity disposed at respective positions across at least one dimension of the excimer lamp, and a gas within the sealed cavity, the gas being capable of emitting ultraviolet light in response to excitation of the electrode array.

### RELATED APPLICATIONS

This patent claims priority under 35 U.S.C. § 119(e) to U.S. Provisional Application No. 63/387,410, titled “EXCIMER LAMP,” filed on Dec. 14, 2022, and U.S. Provisional Application No. 63/505,754, titled “EXCIMER LAMP ENVELOPE UV FILTER,” filed on Jun. 2, 2023, each of which is hereby incorporated by reference herein in their entireties.

### FIELD

The techniques described herein relate generally to ultraviolet light emission and, more particularly, to excimer lamps.

### BACKGROUND

Excimer lamps emit ultraviolet (UV) light based on the excitation of gasses including diatomic or polyatomic molecules (excimers). UV light in the UV-C (or UVC) range (100-280 nanometers (nm)) is capable of killing viruses and other pathogens. Excimer lamps that emit UV light in such a wavelength range may be used to sterilize an area exposed to the excimer lamps.

### SUMMARY

In accordance with the disclosed subject matter, apparatus, systems, and methods are provided for excimer lamps.

Some embodiments relate to an excimer lamp. The excimer lamp comprises a dielectric forming at least one side of a sealed cavity, an electrode array disposed over a surface of the dielectric, the electrode array comprising a plurality of electrodes of alternating polarity disposed at respective positions across at least one dimension of the excimer lamp, and a gas within the sealed cavity, the gas being capable of emitting ultraviolet light in response to excitation of the electrode array.

Some embodiments relate to an excimer lamp system. The excimer lamp system comprises a lamp comprising a dielectric forming at least one side of a sealed cavity; an electrode array disposed over a surface of the dielectric, the electrode array comprising a plurality of electrodes of alternating polarity disposed at respective positions across at least one dimension of the lamp, a window, and a gas within the sealed cavity, the gas being capable of emitting ultraviolet light through the window in response to excitation of the electrode array.

Some embodiments relate to a method of operating an excimer lamp comprising a dielectric forming at least one side of a sealed cavity and an electrode array disposed over a surface of the dielectric, the electrode array comprising a plurality of electrodes disposed at respective positions across at least one dimension of the excimer lamp, the excimer lamp further comprising a gas within the sealed cavity, the gas being capable of emitting ultraviolet light in response to excitation of the electrode array. The method comprises driving adjacent electrodes of the plurality of electrodes with voltages of alternating polarity.

The foregoing summary is not intended to be limiting. Moreover, various aspects of the present disclosure may be implemented alone or in combination with other aspects.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows a top view of an example electrode configuration for an example excimer lamp in which polarities of electrodes of the electrode configuration alternate only along a first dimension, according to some embodiments.

FIG. 2 shows a top view of another example electrode configuration for an example excimer lamp in which polarities of electrodes of the electrode configuration alternate along both a first dimension and a second dimension, according to some embodiments.

FIG. 3 shows a cross-sectional view of a two-dimensional excimer lamp, according to some embodiments.

FIG. 4A shows an example implementation of an excimer lamp having two sealed tubes filled with gas, according to some embodiments.

FIG. 4B shows a cross-sectional view of one of the two sealed tubes of FIG. 4A, according to some embodiments.

FIG. 5 shows an exploded view of an example implementation of an excimer lamp system, according to some embodiments.

FIG. 6 shows a plot of transmission with respect to wavelength for a tested piece of quartz doped with cerium oxide, without titanium oxide, according to some embodiments.

FIG. 7 is a flowchart representative of an example process that may be performed and/or implemented to manufacture, calibrate, test, and/or operate an excimer lamp, such as one(s) of the example excimer lamps of FIGS. 1, 2, 3, 4A, and/or 4B, and/or an excimer lamp system, such as the excimer lamp system of FIG. 5, according to some embodiments.

### DETAILED DESCRIPTION

As discussed above, excimer lamps emit ultraviolet (UV) light responsive to excitation of gasses including excimers. Although light in the UV-C range (e.g., a wavelength range of 100-280 nanometers (nm)) may be used for disinfection purposes, some wavelengths of UV-C light are less harmful to human health than others. In particular, it has been found that wavelengths of less than 230 nm are less harmful to human health than longer UV-C wavelengths.

In some applications, excimer lamps may be used to sterilize an area and, in particular, it may be desirable to sterilize a large area. The inventor has recognized and appreciated that existing solutions for sterilizing an area (e.g., a large area) use a number of small tubular lamps capable of emitting UV light. Some challenges the inventor has recognized when sterilizing a large area is that either a greater number of small tubular lamps are needed to emit sufficient UV light to expose the large area or a fewer number of small tubular lamps are used but additional time is required to expose the large area (e.g., additional time for person(s) to move the fewer number of small tubular lamps around the large area). Another challenge with small tubular lamps that the inventor has recognized is that such lamps may be expensive to manufacture and/or have low reliability. Yet another recognized challenge with small tubular lamps is that prior lamps constructed as tubes may have electrodes on either end of the tubes. The inventor has recognized that such lamps are limited to a small size, which contribute to the aforementioned challenges when sterilizing a large area.

The inventor has developed technology for excimer lamps that overcome the aforementioned challenges. Described herein are excimer lamps that can be formed in relatively large sizes, and which avoid the disadvantages of prior excimer lamp designs for disinfecting large areas. In some embodiments, instead of or in addition to positioning electrodes at the ends of a sealed cavity, an array of electrodes of alternating polarity may be positioned across the surface of the sealed cavity. In some embodiments, the electrodes may be spaced apart from one another by 8-12 millimeters (mm) or less. Beneficially, positioning an array of electrodes across the surface of the sealed cavity allows the forming of excimer lamps in a range of sizes, including those larger than conventional excimer lamp designs.

In some embodiments, an excimer lamp with an array of electrodes may be formed in a two-dimensional geometry (e.g., a flat geometry, a planar geometry). In such a lamp, a gas comprising excimer molecules is confined between top and bottom substrates that extend in two dimensions in a suitable shape, which may be a square, rectangular, triangular, and/or helical shape. The substrates may have a planar geometry or a curved geometry, and are not limited to being strictly flat. An electrode array on at least one of the substrates may excite the excimer gas, while the substrate opposite the electrode array may provide a transparent window to allow the UV light to exit the lamp. In some embodiments, illumination may be provided from across the transparent window. In some such embodiments, the transparent window may be a two-dimensional window having any area such as approximately a 1-4 square foot area or larger.

In some embodiments, an excimer lamp may include an array of electrodes spaced apart from one another along a first dimension. For example, a tube formed of a dielectric (e.g., a dielectric material) may form a sealed cavity containing a suitable gas, and an array of electrodes of alternating polarity may be positioned along the length of the tube. Advantageously, the tube may be formed of any length, with a larger number of electrodes allowing for longer lamps and therefore allowing longer arc lengths.

By forming the tube of any length to allow for longer lamps, the technology developed by the inventor overcomes the challenge of prior lamps when sterilizing large areas. Additionally, by allowing for longer lamps, the technology developed by the inventor improves reliability and/or reduces cost of manufacture by reducing the number of individual lamps being constructed. In some embodiments, the excimer lamp may include a plurality of tubes, each having an array of electrodes of alternating polarity.

Further advantages of the excimer lamps described herein include the lack of need for a reflector, and the elimination of need for the UV light to pass through a mesh, which in standard designs may block a portion of the UV light, thereby reducing efficiency. Non-limiting examples of applications in which the excimer lamps described herein may be used include air disinfection, air purification, surface area disinfection, and water disinfection.

As mentioned above, the elimination of need for the UV light to pass through a mesh can be achieved by constructing the lamp envelope itself to filter UV light in a desired manner without the need for a separate spectral filter. For example, some prior excimer lamps have secondary outputs of UV light with wavelengths harmful to human health. By way of example, although krypton-chloride (KrCl) excimer lamps have most of their output around 222 nm, there is also a secondary output at 257 nm. Likewise, krypton-bromide (KrBr) excimer lamps have most of their output around 208 nm, with a secondary output at 228 nm and 291 nm. These secondary outputs of wavelengths longer than 230 nm may be undesirable because it limits the amount of “good UV” an excimer lamp is allowed to generate based on regulatory maximum exposure limits (e.g., threshold limit values (TLV)) for the “bad UV”.

The standard industry solution to attenuate wavelengths greater than 230 nm is to utilize a filter to remove the undesirable wavelengths. This filter may either be an absorbing filter for the undesirable wavelength or a reflective filter for the undesirable wavelength, the latter reflecting the harmful radiation away from humans.

This undesirable wavelength filter can take the form of a single layer or multi-layer dielectric coating applied to a quartz or sapphire substrate that is placed in the exit window of the appliance containing the excimer lamp, or alternatively, this dielectric filter can be applied or deposited to one or both of the surfaces or envelope of the excimer lamp bulb.

Suitable single and multilayer filter stacks can be made through various deposition techniques and comprise dielectric materials such as silicon oxide, hafnium oxide and aluminum oxide. Of these materials, hafnium oxide and aluminum oxide have been preferred based on their ability to withstand UV radiation in general without significant deterioration over the lifetime of the product.

Such a spectral filter may include one or more dielectric layers. Such filters are designed to pass UV light around 222 nm while blocking UV light of longer and more harmful wavelengths. The inventors have recognized and appreciated that such UV filters add cost to the system. Additionally, and perhaps more importantly, such filters also reduce the amount of “good” UV output in a very significant manner.

The inventors also recognize that in the case of filter performance shift over its lifespan, or mechanical failure of the filter at the system level, increased transmission of UV light wavelengths longer than 230 nm may occur. Additionally, flat dielectric filters may have impaired off-axis response rendering the output of the appliance non-uniform, greatly affecting the virus killing abilities of the appliance in low output areas and giving human occupants of the space a false sense of security.

In some embodiments, an excimer lamp can be constructed such that the lamp envelope itself can filter the UV light in a desired manner without the need for a separate spectral filter. Such an excimer lamp may include a lamp envelope including a dielectric material that confines a gas. The dielectric material of the lamp envelope itself may be manufactured to filter UV light in a desired manner. For example, the dielectric material of the lamp envelope may be manufactured to have relatively high transmission of UV light in the band of 190-230 nm, and to have relatively low transmission of UV light of longer wavelengths that may be harmful to human health. The lamp envelope may be formed of a suitable dielectric material such as quartz or sapphire, for example. The dielectric material may be doped to obtain suitable optical properties, including having a relatively high transmission of UV light in the band of 190-230 nm, and to have relatively low transmission of UV light of longer wavelengths, particularly longer than 250 nm. Such a technique can avoid the need for a separate filter and in some cases may provide improved off-axis spectral filtering.

Commercially available cerium doped fused silica (also called cerium doped quartz) and titanium doped fused silica (also called titanium doped quartz) were explored for application in excimer lamps. However, both options completely block the “good UV” output (190-230 nm).

The inventors realized that the commercially available cerium doped fused silica actually includes both cerium oxides and titanium oxides as dopants and that this combination leads to blocking off the transmission of good UV. Therefore, the inventors developed a quartz doping scheme where cerium oxides exclusively were used as dopants. This resulted in the good UV not being blocked.

Various concentrations and formulations of cerium oxides were used to develop doped dielectric quartz material, and each concentration led to a different value of output at 222 nm and 257 nm. The formulations tried were successful in increasing the ratio of 222 nm to 257 nm favorably to the point where output of 257 nm is low enough that only the threshold limit value (TLV) for 222 nm needs be considered. For an undoped tube, the emission at 257 nm will trigger TLV safety requirements even if the 222 nm is within a safe level.

The advantages of the excimer lamps manufactured with this improved and new doped dielectric quartz material (or glass or sapphire material) is that no external filter is required for practical disinfection applications requiring human health protection from damaging UV radiation.

The lamp envelope may take any suitable shape, such as a tubular shape, a coaxial tubular shape, or a mostly flat shape. The lamp envelope forms a sealed cavity to contain the gas that is configured to emit UV light in response to excitation. The excitation may take any suitable form, such as electrical or optical excitation (e.g., using a laser). If the excitation is performed electrically, electrodes may be located at any suitable position, such as at the end of a cavity or covering the surface of the lamp with a wire-mesh electrode.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

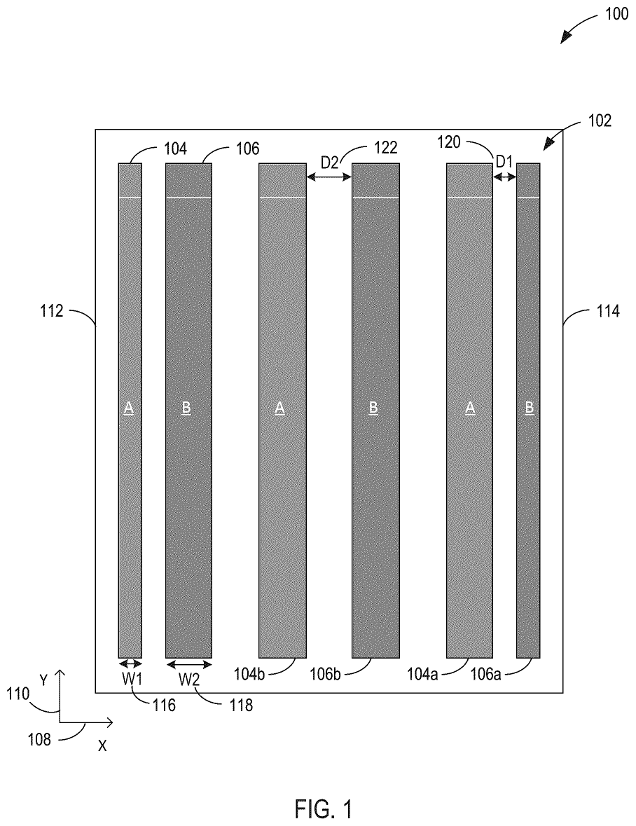

Turning to the figures, the illustrated example of FIG. 1 shows a top view of a first example excimer lamp 100 having a first example electrode configuration 102. The first electrode configuration 102 is an array of electrodes (e.g., an electrode array) that includes a plurality of electrodes 104, 106 whose polarities alternate only along a first dimension 108, which is the X dimension in this example. A different number of electrodes may be used than the number shown in FIG. 1. The first electrode configuration 102 has a pattern that may be considered to be a “stripe” pattern. In example operation, the first excimer lamp 100 emits UV light in response to excitation of one(s) of the plurality of electrodes 104, 106. For example, electrical arcs can be generated in response to excitation of one(s) of the plurality of electrodes 104, 106 and span across the excited one(s) of the plurality of electrodes 104, 106.

The first electrode configuration 102 includes a first set of electrodes 104 with each electrode in the first set of electrodes 104 identified by “A”. Each electrode in the first set of electrodes 104 is configured to be provided with a voltage (e.g., 5 kV) of a first polarity (e.g., a first voltage polarity, a positive voltage polarity such as +5 kV). The first electrode configuration 102 includes a second set of electrodes 106 with each electrode in the second set of electrodes 106 identified by “B”. Each electrode in the second set of electrodes 106 is configured to be provided with a voltage (e.g., 5 kV) of a second polarity (e.g., a second voltage polarity, a negative voltage polarity such as −5 kV), where the second polarity is opposite and/or otherwise different from the first polarity. For example, electrode 106a can have a voltage of −5 kV, electrode 104a can have a voltage of +5 kV, electrode 106b can have a voltage of −5 kV, electrode 104b can have a voltage of +5 kV, and so on, such that adjacent pairs have alternating polarity that can be used for arc generation across the adjacent pairs. In such an example, the arc length can be extended across the length of the plurality of electrodes 104, 106 along the first dimension 108.

In the illustrated example, the same nominal voltage is applied to each of the plurality of electrodes 104, 106. Alternatively, one(s) of the plurality of electrodes 104, 106 may be provided with different nominal voltages. For example, a first electrode in the first set of electrodes 104 may be supplied with a first nominal voltage and a second electrode in the first set of electrodes 104 may be supplied with a second nominal voltage, where the second nominal voltage is different from the first nominal voltage. By way of another example, an electrode in the first set of electrodes 104 may be supplied with a first nominal voltage and an electrode in the second set of electrodes 106 may be supplied with a second nominal voltage, where the second nominal voltage is different from the first nominal voltage.

In the illustrated example of FIG. 1, each of the plurality of electrodes 104, 106 has a rectangular shape. Alternatively, one or more of the plurality of electrodes 104, 106 may have a different shape, such as a square shape, a triangular shape, or a helical shape. In the illustrated example, each of the plurality of electrodes 104, 106 has the same length along a second dimension 110, which is the Y dimension in this example. Alternatively, one or more of the plurality of electrodes 104, 106 may have a different length.

In the illustrated example, a first electrode in the first set of electrodes 104 that is closest to a first side 112 of the first excimer lamp 100 and a second electrode in the second set of electrodes 106 that is closest to a second side 114 of the first excimer lamp 100, where the second side 114 is opposite the first side 112, each have a first width 116 (identified by W1) in the first dimension 108. Other ones of the plurality of electrodes 104, 106 have a second width 118 (identified by W2) in the first dimension 108 that is wider than the first width 116. In this example, narrower electrodes near and/or otherwise closer to the edges of the first excimer lamp 100 may assist with and/or support equalization of the electrode capacitance over the electrode array in such a way that the plasma distribution can be made more homogeneous. For example, the surface (e.g., the surface area) of the electrodes 104, 106 can be used to equalize the capacitance between lamp segments. At the ends of the cavity of the first excimer lamp 100, the two shown narrower electrodes are approximately equal to half the size (surface wise) than the wider electrodes not at the end of the excimer lamp 100. Advantageously, equalizing the capacitance between the electrodes 104, 106 by manipulating the surface of the electrodes 104, 106 can be carried out to homogenize the operating voltage of each lamp segment and, as such, the plasma distribution across the lamp segment(s).

Further shown in this example, each of the plurality of electrodes 104, 106 have the same length in the second dimension 110, but in other embodiments one(s) of the plurality of electrodes 104, 106 may have different lengths than other one(s) of the plurality of electrodes 104, 106. Also shown in this example, a first spacing 120 (identified by D1) between adjacent electrodes near the edges of the first excimer lamp 100 (e.g., electrodes identified by 104a, 106a) is smaller (e.g., shorter) than a second spacing 122 (identified by D2) between adjacent electrodes further away from the edges of the first excimer lamp 100 (e.g., electrodes identified by 104b, 106b).

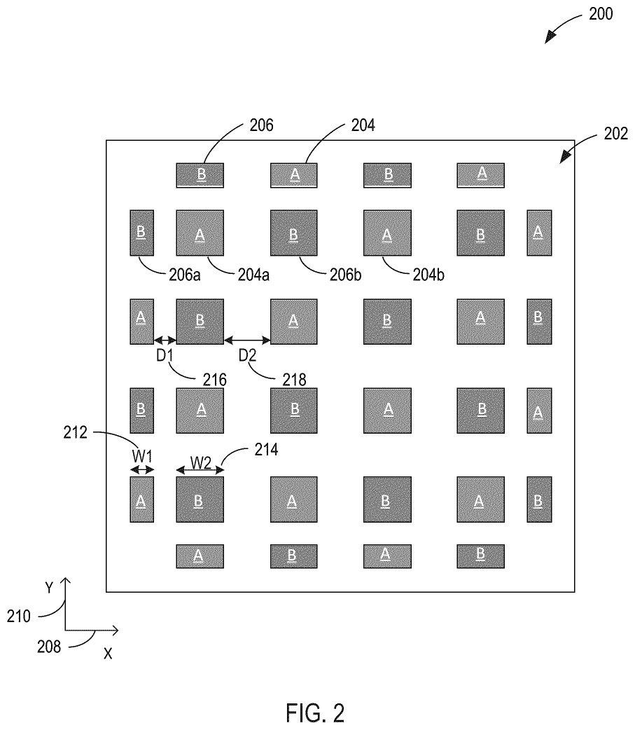

FIG. 2 shows a top view of a second example excimer lamp 200 having a second example electrode configuration 202. The second electrode configuration 202 is an electrode array that includes a plurality of electrodes 204, 206 whose polarities alternate along both a first dimension 208 and a second dimension 210, which are the X and Y dimensions in this example, respectively. A different number of electrodes may be used than the number shown in FIG. 2. The second electrode configuration 202 has a pattern that may be considered to be a “checkerboard” pattern, with spaces or dielectric material between the adjacent electrodes. In example operation, the second excimer lamp 200 emits UV light in response to excitation of one(s) of the plurality of electrodes 204, 206. For example, electrical arcs can be generated in response to excitation of one(s) of the plurality of electrodes 204, 206 and span across the excited one(s) of the plurality of electrodes 204, 206.

The second electrode configuration 202 includes a first set of electrodes 204 with each electrode in the first set of electrodes 204 identified by “A”. Each electrode in the first set of electrodes 204 is configured to be provided with a voltage of a first polarity (e.g., a first voltage polarity). The second electrode configuration 202 includes a second set of electrodes 206 with each electrode in the second set of electrodes 206 identified by “B”. Each electrode in the second set of electrodes 206 is configured to be provided with a voltage of a second polarity (e.g., a second voltage polarity), where the second polarity is opposite and/or otherwise different from the first polarity. For example, electrode 206a can have a voltage of −10 kV, electrode 204a can have a voltage of +10 kV, electrode 206b can have a voltage of −10 kV, electrode 204b can have a voltage of +10 kV, and so on, such that adjacent pairs have alternating polarity that can be used for arc generation across the adjacent pairs. In such an example, the arc length can be extended across the length of the plurality of electrodes 204, 206 along the first dimension 208 and/or the second dimension 210.

In the illustrated example, the same nominal voltage is applied to each of the plurality of electrodes 204, 206. Alternatively, one(s) of the plurality of electrodes 204, 206 may be provided with different nominal voltages. For example, a first electrode in the first set of electrodes 204 may be supplied with a first nominal voltage and a second electrode in the first set of electrodes 204 may be supplied with a second nominal voltage, where the second nominal voltage is different from the first nominal voltage. By way of example, an electrode in the first set of electrodes 204 may be supplied with a first nominal voltage and an electrode in the second set of electrodes 206 may be supplied with a second nominal voltage, where the second nominal voltage is different from the first nominal voltage.

Although the plurality of electrodes 204, 206 are shown as having a square or rectangular shape in top-view, one(s) of the plurality of electrodes 204, 206 may have any shape in top-view. For example, one(s) of the plurality of electrodes 204, 206 may have circular shapes (e.g., dot shapes) or other shapes with curved (e.g., cylindrical shapes, crescent shapes) and/or straight edges (e.g., triangular shapes, pentagonal shapes, hexagonal shapes, and so forth). Ones of the plurality of electrodes 204, 206 may be narrower near and/or closer to the edges of the excimer lamp 200, as illustrated in FIG. 2, or in other embodiments may not have electrodes that are narrower near and/or closer to the edges. For example, narrower electrodes near the edges of the excimer lamp 200 may help to equalize the electrode capacitance over the electrode array in such a way that the plasma distribution can be made more homogeneous.

In the illustrated example, electrodes of the plurality of electrodes 204, 206 that are closest to and/or proximate to the sides of the second excimer lamp 200 each have a first width 212 (identified by W1) along the first dimension 218. Other ones of the plurality of electrodes 204, 206 have a second width 214 (identified by W2) along the first dimension 218 that is wider than the first width 212. For example, narrower electrodes near the edges of the second excimer lamp 200 may assist with and/or support equalization of the electrode capacitance over the electrode array in such a way that the plasma distribution can be made more homogeneous. Also shown in this example, a first spacing 216 (identified by D1) between adjacent electrodes near the edges of the second excimer lamp 200 is smaller than (e.g., shorter) a second spacing 218 (identified by D2) between adjacent electrodes away from the edges of the second excimer lamp 200.

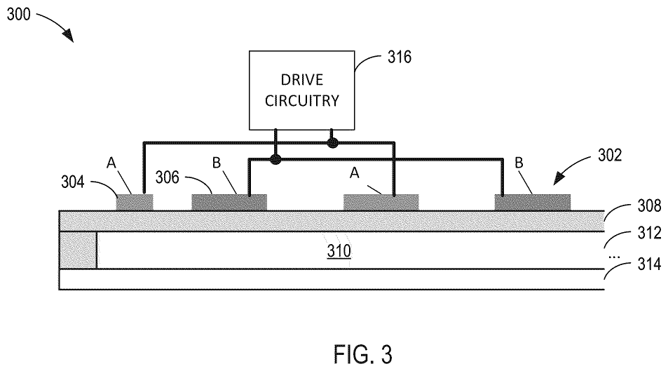

FIG. 3 shows a cross-sectional view of a third example excimer lamp 300. The third excimer lamp 300 is shown as a two-dimensional excimer lamp. In some embodiments, the third excimer lamp 300 can implement the first excimer lamp 100 of FIG. 1. For example, the third excimer lamp 300 can have an electrode configuration with a stripe pattern. In some embodiments, the third excimer lamp 300 can implement the second excimer lamp 200 of FIG. 2. For example, the third excimer lamp 300 can have an electrode configuration with a checkerboard pattern. Alternatively, the third excimer lamp 300 may have any other electrode configuration.

The third excimer lamp 300 includes an electrode array 302 with alternating electrodes 304, 306 at different voltages. For example, the electrode array 302 includes a plurality of electrodes 304, 306 of opposite polarities with suitable spacings. Those of ordinary skill in the art will understand how to select a suitable spacing between adjacent ones of the plurality of electrodes 304, 306. For example, adjacent ones of the plurality of electrodes 304, 306 can be spaced apart by a distance in a range of no more than 8-12 millimeters (mm). As discussed above, the electrode array 302 of this example can be arranged and/or organized in one of a variety of electrode configurations as described herein.

The electrode array 302 of the depicted example includes a first set of electrodes 304 with each electrode in the first set of electrodes 304 identified by “A”. Each electrode in the first set of electrodes 304 is configured to be provided with a voltage of a first polarity (e.g., a first voltage polarity). The electrode array 302 includes a second set of electrodes 306 with each electrode in the second set of electrodes 306 identified by “B”. Each electrode in the second set of electrodes 306 is configured to be provided with a voltage of a second polarity (e.g., a second voltage polarity), where the second polarity is opposite and/or otherwise different from the first polarity.

The electrode array 302 is disposed on or over a dielectric 308. The dielectric 308 in this example is a material (e.g., a dielectric material) shown as a first two-dimensional substrate. The dielectric 308 may be formed of any of a variety of dielectric materials. Non-limiting examples of dielectric materials include glass, quartz, sapphire, and ceramic materials. In some embodiments, the dielectric 308 is opaque to UV light. In some embodiments, the dielectric 308 is transparent to UV light.

A gas 310 is enclosed, sealed, and/or encapsulated within a cavity 312 between the dielectric 308 and a window 314. The window 314 of this example is a transparent window shown as a second two-dimensional substrate. When excited by the electrode array 302, the gas 310 emits UV light, which exits the third excimer lamp 300 through the transparent window 314.

The window 314 can be constructed and/or formed of any of a variety of materials that allow UV light of desired wavelength(s) to pass through. Non-limiting examples of window materials include glass, quartz, and sapphire. In some embodiments, the window 314 can be coated and/or doped to absorb and/or attenuate unwanted wavelengths such that wanted wavelengths can be transmitted through the window 314. For example, the window 314 can be coated and/or doped to absorb and/or prevent UV length with a wavelength (e.g., a peak wavelength) of 257 nanometers (nm) from being transmitted through the window 314. By way of example, the window 314 can be doped or otherwise manufactured to have a relatively high transmission of UV light in the range of 190-230 nm and to have a relatively low transmission of UV light of longer wavelengths than 230 nm. In some embodiments, the window 314 can be doped with cerium oxide to block unwanted longer wavelengths of UV light. To avoid attenuating wavelengths between 190 nm and 230 nm to an excessive degree, the window 314 may not be doped with titanium oxide. As a result of the lack of doping with titanium oxides, the window 314 may be free of or substantially free of titanium oxide. In some embodiments, the window 314 can be a unitary structure (e.g., of glass, quartz, or sapphire). In some embodiments, the window 314 itself can perform the spectral filtering to remove UV of wavelengths greater than 230 nm, and accordingly may not be covered with a separate spectral filter. As used herein, the term “transparent” refers to the ability of a window, such as the window 314, to pass light in the desired wavelength and includes any level of transparency from partial transparency to complete transparency.

The dielectric 308 can be joined to the electrode array 302 and/or the transparent window 314 by any suitable technique. For example, the dielectric 308 can be attached and/or joined to the electrode array 302 by brazing, gluing, soldering, and/or welding. In another example, the dielectric 308 can be attached and/or joined to the window 314 by brazing, gluing, soldering, and/or welding.

The dielectric 308 can be rigid or flexible. The window 314 can be rigid or flexible. For example, a rigid construction can be useful for various application, such as for being mounted in/on a ceiling, wall, or floor. In another example, a flexible construction can allow a lamp, such as the third excimer lamp 300, to bend and/or flex to accommodate installation on non-planar or irregular surfaces.

The gas 310 of this example fills the sealed cavity 312 between the dielectric 308 and the window 314. In some embodiments, the gas 310 can have a pressure lower than atmospheric pressure. Alternatively, the gas 310 may have a pressure at atmospheric pressure or higher than atmospheric pressure.

The gas 310 contained within the cavity 312 can be any suitable gas of diatomic or polyatomic molecules that emits UV radiation in response to excitation of ones of the plurality of electrodes 304, 306. The gas 310 can be a single gas or a mixture of a plurality of gasses. Non-limiting examples of the gas 310 include a krypton-chloride (KrCl) gas mixture and a krypton-bromide (KrBr) gas mixture. For example, the third excimer lamp 300 can emit UV light at a peak wavelength of 222 nm when the gas 310 is a KrCl gas mixture. In another example, the third excimer lamp 300 can emit UV light at a peak wavelength of 207 nm when the gas 310 is a KrBr gas mixture.

When excited by ones of the plurality of electrodes 304, 306, the gas 310 can emit light with a peak wavelength in the range of 100-230 nm, or 200-230 nm, for example. For example, the gas 310 can emit light with a peak wavelength in a range of greater than or equal to 100 nm to less than or equal to 230 nm, or in a range of greater than or equal to 200 nm to less than or equal to 230 nm. Any other range of peak wavelengths is contemplated. In another example, when excited by ones of the plurality of electrodes 304, 306, the gas 310 can emit light with a peak wavelength of 208 nm. In yet another example, when excited by ones of the plurality of electrodes 304, 306, the gas 310 can emit light with a peak wavelength of 222 nm.

In the illustrated example, the third excimer lamp 300 additionally includes drive circuitry 316 for driving the plurality of electrodes 304, 306. The drive circuitry 316 is configured to generate and/or output a drive waveform for excitation of ones of the plurality of electrodes 304, 306. Non-limiting examples of drive waveforms include sinusoidal and pulsed waveforms (e.g., pulse-width modulation (PWM) waveforms)). Any other type of drive waveform is contemplated. For example, those of ordinary skill in the art will understand how to select suitable a suitable drive waveform and suitable voltage, current, and/or power levels based on the lamp geometry, materials, type of gas, and/or other criteria for emission of UV light having a desired peak wavelength.

In some embodiments, the drive circuitry 316 includes one or more switches configured to drive the plurality of electrodes 304, 306 at a controlled frequency. Non-limiting examples of switches include micro-electro-mechanical (MEMS) switches and transistors. Any other type of switch is contemplated. Non-limiting examples of transistors include a field-effect transistor (FET), a bipolar junction transistor (BJT) (e.g., an NPN BJT, a PNP BJT), and an insulated-gate bipolar transistor (IGBT). Non-limiting examples of FETs include power FETs and metal-oxide-semiconductor field-effect transistors (MOSFETs) (e.g., p-channel MOSFETs, n-channel MOSFETs, etc.). Any other type of transistor is contemplated.

In some embodiments, the drive circuitry 316 includes one or more power supplies and/or is configured to be coupled to one or more power supplies. The one or more power supplies can be configured to output suitable current, voltage, and/or power levels for driving of the plurality of electrodes 304, 306. For example, the one or more power supplies can be an alternating current (AC) power source (e.g., an electrical wall outlet that can provide AC power) configured to output a voltage up to and including 20 kilovolts (kV) (e.g., 20 kV peak-to-peak, 20 kV AC peak-to-peak). Any other output voltage is contemplated such as a voltage up to and including 5 kV (e.g., 5 kV peak-to-peak, 5 kV AC peak-to-peak), 10 kV (e.g., 10 kV peak-to-peak, 10 kV AC peak-to-peak), etc. In another example, the one or more power supplies can be a direct current (DC) power source (e.g., a 24 volts direct current (VDC) power source, a 48 VDC power source), which can be converted from DC voltage to AC voltage via a DC-AC power converter.

In the illustrated example, the same nominal voltage is applied to each of the plurality of electrodes 304, 306. Alternatively, one(s) of the plurality of electrodes 304, 306 may be provided with different nominal voltages. For example, a first electrode in the first set of electrodes 304 may be supplied with a first nominal voltage from a first power supply and a second electrode in the first set of electrodes 304 may be supplied with a second nominal voltage from a second power supply (or the first power supply), where the second nominal voltage is different from the first nominal voltage. By way of another example, a first electrode in the first set of electrodes 304 may be supplied with a first nominal voltage from a first power supply and a second electrode in the second set of electrodes 306 may be supplied with a second nominal voltage from a second power supply (or the first power supply), where the second nominal voltage is different from the first nominal voltage.

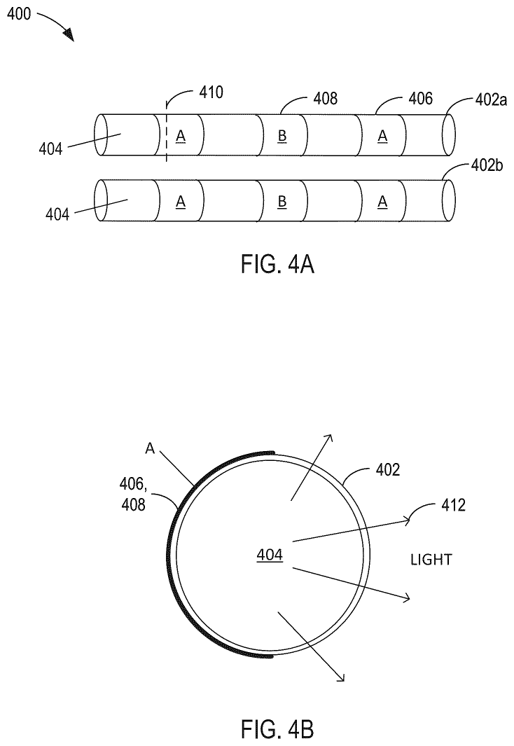

The inventor has recognized and appreciated that the apparatus and techniques described herein may be applied to a lamp (e.g., an excimer lamp) having one or more sealed tubes, which is depicted in FIG. 4A. For example, the inventor has recognized and appreciated that lamps having one or more sealed tubes may be easier to construct, fabricate, and/or manufacture than lamps having one or more non-tubular structures.

FIG. 4A shows an example of a fourth excimer lamp 400 having two example sealed tubes 402a, 402b (collectively 402). The tubes 402 of this example are circular tubes such as having a cylindrical shape (e.g., cylindrical tubes). Alternatively, the tubes 402 may have a different shape. For example, one(s) of the tubes 402 may be triangular tubes (e.g., tubes with a V-shape), rectangular tubes, pentagonal tubes, hexagonal tubes, and so forth. The tubes 402 of this example can be constructed to have any desired length. For example, each of the tubes 402 can have a length of 600 mm (e.g., approximately 2 feet), a length of 1200 mm (e.g., approximately 4 feet), and so on by adding additional electrodes of alternating polarity along the length of the tubes 402.

The tubes 402 of this example can be tubes of dielectric material such as that described above for the dielectric 308 of FIG. 3 and filled with one or more gasses 404 such as the gas 310 of FIG. 3. However, a lamp may be formed of any number of the tubes 402, such as one tube, two tubes, or more, such as four tubes, eight tubes, or any other number of tubes. The tubes 402 may be formed of a transparent material such as glass, for example. Alternatively, the tubes 402 may be formed of a different transparent material such as quartz or sapphire. In some embodiments, the material for the envelope (e.g., the outer surface) of the tubes 402 can be doped with cerium oxide to block unwanted longer wavelengths of UV light. To avoid attenuating wavelengths between 190 nm and 230 nm to an excessive degree, the material for the envelope of the tubes 402 may not be doped with titanium oxide. As a result of the lack of doping with titanium oxides, the envelope of the tubes 402 may be free of or substantially free of titanium oxide.

Each tube 402 of this example has a plurality of electrodes 406, 408 disposed on the curved side of the tube 402 such that UV light can be transmitted along the edges of the tube 402. The plurality of electrodes 406, 408 include a first set of electrodes 406 (each electrode respectively identified by “A”) and a second set of electrodes 408 (each electrode respectively identified by “B”). Each electrode in the first set of electrodes 406 can have a first polarity (e.g., a first voltage polarity). Each electrode in the second set of electrodes 408 can have a second polarity (e.g., a second voltage polarity). In some embodiments, the first polarity is opposite the second polarity.

The plurality of electrodes 406, 408 can be formed of any suitable electrical conductor, such as a metal, for example. Non-limiting examples of electrical conductors include aluminum, copper, nickel, stainless steel, and chrome-plated materials. Forming the electrodes 406, 408 of a reflective conductor, such as aluminum, for example, may increase light transmission efficiency by reflecting the UV light back out the opposite side of the fourth excimer lamp 400. In some embodiments, each of the plurality of electrodes 406, 408 can be formed of the same electrical conductor. Alternatively, one(s) of the plurality of electrodes 406, 408 may be formed of different electrical conductors. For example, one(s) in the first set of electrodes 406 can be formed of a first electrical conductor, such as aluminum, and one(s) of the second set of electrodes 408 can be formed of a second electrical conductor, such as stainless steel. By way of another example, first one(s) in the first set of electrodes 406 can be formed of a first electrical conductor, such as aluminum, and second one(s) in the first set of electrodes 406 can be formed of a second electrical conductor, such as stainless steel.

The plurality of electrodes 406, 408 may be in contact with the tube 402, as illustrated in FIG. 4B, which shows a cross-sectional view of one of the tubes 402 along the dashed line 410 of FIG. 4A. As illustrated in FIG. 4B, the electrodes 406, 408 may extend for approximately 180 degrees (e.g., extend 180 degrees, extend in a range of 179 to 181 degrees, etc.) around the circumference of the tube 402. However, this is an example, and in other cases an electrode may extend around more (e.g., 185 degrees, 200 degrees, etc.) or less (e.g., 175 degrees, 160 degrees, etc.) of the circumference of the tube 402. The electrodes 406, 408 of this example have an arc shape that conforms to the shape of the tube 402. Alternatively, one(s) of the plurality of electrodes 406, 408 may have a different shape, such as a V-shape, for example. In the illustrated example, the shape of the tube 402 can effectuate the emission of UV light in a direction identified by shown arrows 412.

As discussed in connection with the other excimer lamps 100, 200, 300 described herein, the fourth excimer lamp 400 includes electrodes A and B with a polarity that alternates along the length of the tube 402. In some embodiments, there may be a single power supply or single instance of the drive circuitry 316 of FIG. 3 for the electrodes of all the tubes of the fourth excimer lamp 400. In other embodiments, there may be a separate power supply or separate instances of the drive circuitry 316 for driving the electrodes of each tube of the fourth excimer lamp 400, such as in the case of longer lamps.

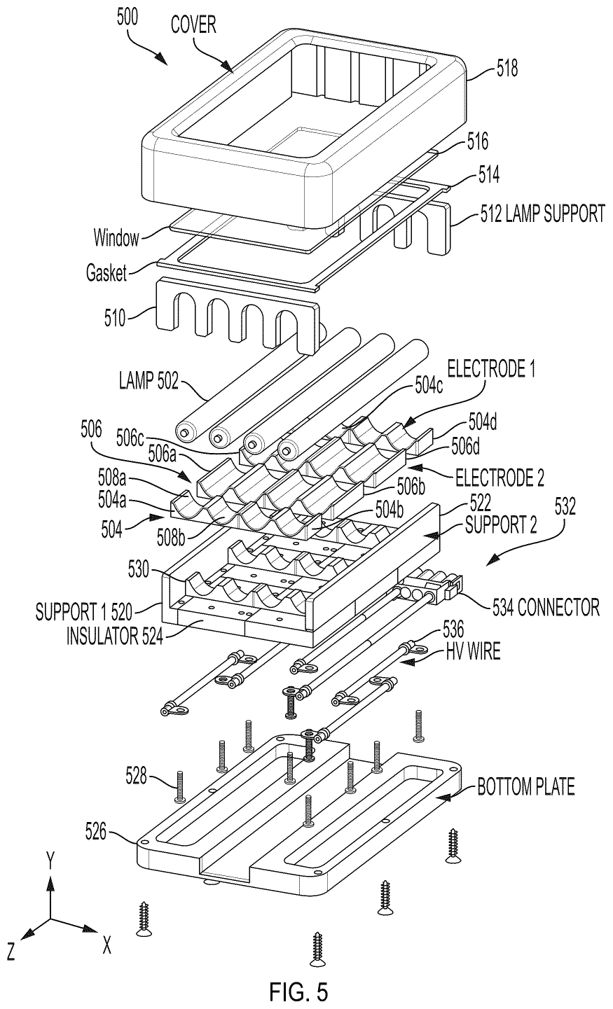

FIG. 5 shows an exploded view of an example implementation of an excimer lamp system 500. In some embodiments, the excimer lamp system 500 can implement the first excimer lamp 100 of FIG. 1, the second excimer lamp 200 of FIG. 2, the third excimer lamp 300 of FIG. 3, and/or the fourth excimer lamp 400 of FIGS. 4A and 4B.

The excimer lamp system 500 of the illustrated example includes a plurality of lamps 502. The plurality of lamps 502 of this example is a set of four excimer lamps constructed as tubes. Alternatively, the excimer lamp system 500 may include a different number of excimer lamps. Each of the plurality of lamps 502 shown is constructed as circular and/or cylindrical tubes, but alternatively may have any other shape. For example, one(s) of the plurality of lamps 502 may be constructed as a V-shaped tube, a rectangular tube, etc. In some embodiments, each of the plurality of lamps 502 can be implemented by one of the tubes 402a, 402b of FIG. 4A and/or the tube 402 of FIG. 4B. For example, each of the plurality of lamps 502 can include one or more dielectric surfaces extending lengthwise along the lamps 502.

In the illustrated example, the lamps 502 are attached to a plurality of electrodes 504, 506. The plurality of electrodes 504, 506 of this example includes a first set of electrodes 504 and a second set of electrodes 506. The first set of electrodes 504 in this example is to be excited by a voltage of a first polarity and the second set of electrodes 506 is to be excited by a second voltage of a second polarity, opposite the first polarity.

In the shown example, the first set of electrodes 504 includes four electrodes 504a, 504b, 504c, 504d with two electrodes at each distal end (e.g., electrodes 504a, 504b at a first distal end and electrodes 504c, 504d at a second distal end) of the excimer lamp system 500. In the shown example, the second set of electrodes 506 include four electrodes 506a, 506b, 506c, 506d with two electrodes (e.g., electrodes 506a, 506b) towards the first distal end and two electrodes (e.g., electrodes 506c, 506d) towards the second distal end. Alternatively, a different number of electrodes in the first set of electrodes 504 and/or the second set of electrodes 506 may be used.

Adjacent ones of the electrodes 504a, 504b, 504c, 504d, 506a, 506b, 506c, 506d have alternating polarity. For example, electrode 504a can have a positive voltage polarity, electrode 506a can have a negative voltage polarity, electrode 506c can have a positive voltage polarity, and electrode 504c can have a negative voltage polarity, such that a positive-negative-positive-negative polarity configuration can be implemented across the length of the lamp 502 to effectuate an increased arc length across the length of the lamp 502. In such an example, the arch length can be tripled using this polarity configuration because a first arc can be generated between the positive-negative voltage polarities of electrodes 504a and 506a, a second arc can be generated between the negative-positive voltage polarities of electrodes 506a and 506c, and a third arc can be generated between the positive-negative voltage polarities of electrodes 506c and 504c.

Electrodes in the first set of electrodes 504 have respective widths shorter than respective widths in the second set of electrodes 506 to ensure each electrode system is balanced with respect to the capacitances provided to the excimer lamp system 500. For example, electrodes in the first set of electrodes 504 can have respective widths that are half the respective widths of the electrodes in the second set of electrodes 506 such that electrodes in the first set of electrodes 504 have capacitances that are half the capacitances of electrodes in the second set of electrodes 506.

The plurality of electrodes 504, 506 of this example are constructed as channels with a W-shape. For example, electrode 504a is constructed from an electrically conducting material, such as a metal (e.g., aluminum, copper, nickel, stainless steel, chrome-plated materials), and shaped as two channels. Each of the channels can have a U-shape (such that two adjacent U-shaped channels form a W-shape electrode) configured to removably receive one of the lamps 502. For example, a first channel 508a of electrode 504a can be configured to be removably attached to a first one of the lamps 502 and a second channel 508b of electrode 504a can be configured to be removably attached to a second one of the lamps 502.

In some embodiments, the plurality of electrodes 504, 506 can be of unibody construction. For example, the first channel 508a and the second channel 508b of electrode 504a can be constructed as a single component. Alternatively, the plurality of electrodes 504, 506 can be of multibody construction. For example, the first channel 508a and the second channel 508b of electrode 504a can be constructed as separate components that are attached together via any suitable technique such as soldering or welding.

The plurality of electrodes 504, 506 along the lengths of the lamps 502 achieves the benefit of creating longer lamps, such as by creating a higher power single tube planar system, and therefore creating longer arc lengths (e.g., electrical arc lengths). For example, respective ones of the lamps 502 shown in FIG. 5 can have a length in a range of 500-600 mm. Advantageously, by increasing the number of electrodes and increasing the length of the tube, an overall longer discharge with a higher photonic UV output can be achieved with the excimer lamp system 500 shown in FIG. 5. Advantageously, the excimer lamp system 500 of FIG. 5 can have reduced manufacturing costs (with respect to a lamp system with shorter tubes) by manufacturing longer tubes (such as the lamps 502 shown in FIG. 5) instead of numerous shorter tubes. Advantageously, the excimer lamp system 500 of FIG. 5 has increased reliability with respect to a lamp system with shorter lamps because there are fewer tubes in the excimer lamp system 500 of FIG. 5 than in a lamp system with shorter lamps.

Also shown in FIG. 5 are components for assembly of the excimer lamp system 500. Such components include lamp supports 510, 512, a gasket 514, a window 516, a cover 518, side supports 520, 522, insulators 524, a plate 526, and fasteners 528. There are two lamp supports 510, 512 shown configured with openings to be removably attached to the lamps 502. For example, the openings of the lamp supports 510, 512 can be configured to maintain a spacing between adjacent ones of the lamps 502. The lamp supports 510, 512 are configured to be attached to the side supports 520, 522 and the insulators 524. Although two lamp supports 510, 512 are used in this example, a different number of the lamp supports 510, 512 may be used.

The excimer lamp system 500 includes the gasket 514 to provide a gas-tight seal such that one or more gasses, such as ozone, are prevented from escaping the excimer lamp system 500. The gasket 514 can be constructed of an ozone and/or UV resistant material. The window 516 is disposed between the gasket and the cover 518 such that the cover 518 can be used to compress the gasket 514 against the window 516 and the lamp supports 510. The cover 518 of this example is a rectangular cover configured with an opening (e.g., a rectangular opening) such that UV light emitted through the window 516 can pass through the opening.

The window 516 of this example is a transparent window (may also be an opaque window) configured to allow UV light to be emitted from the excimer lamp system 500. In some embodiments, the window 516 can be constructed of quartz or sapphire. Any other material may be used such as glass. In some embodiments, the material of the window 516 is coated and/or doped such that unwanted UV wavelengths (e.g., UV light with a wavelength of 257 nm) are not emitted. For example, the material for the window 516 can be doped with cerium oxide to block unwanted longer wavelengths of UV light. To avoid attenuating wavelengths between 190 nm and 230 nm to an excessive degree, the material for the window 516 may not be doped with titanium oxide. As a result of the lack of doping with titanium oxides, the window 516 may be free of or substantially free of titanium oxide.

In some embodiments, the excimer lamp system 500 can be configured such that the window 516 is optional. For example, the lamps 502 can be constructed of a material that is coated and/or doped such that unwanted UV wavelengths (e.g., UV light with a wavelength of 257 nm) are not emitted. Additionally or alternatively, the excimer lamp system 500 may include a coated and/or doped window 516 and coated and/or doped lamps 502. For example, the window 516 can be coated and/or doped to prevent UV wavelengths in a first range from being emitted and the lamps 502 can be coated and/or doped to prevent UV wavelengths in a second range from being emitted. In such embodiments, the material for the envelope (e.g., the outer surface) of the lamps 502 can be doped with cerium oxide to block unwanted longer wavelengths of UV light. To avoid attenuating wavelengths between 190 nm and 230 nm to an excessive degree, the material for the envelope of the lamps 502 may not be doped with titanium oxide. As a result of the lack of doping with titanium oxides, the envelope of the lamps 502 may be free of or substantially free of titanium oxide.

To facilitate the assembly of the excimer lamp system 500, the side supports 520, 522 are attached to and extend upwardly from the insulators 524. The side supports 520, 522 can be attached to the cover 518. The side supports 520, 522 of this example can be constructed from an insulating material. The insulators 524 of this example are plates that can be attached to the plate 526. The insulators 524 also include bodies 530 with the same or substantially similar shape as the plurality of electrodes 504, 506. For example, the bodies 530 are W-shaped structures constructed from insulating material(s) and including one or more channels. The bodies 530 of this example are disposed between the sets of electrodes 504, 506 such that a desired spacing between the sets of electrodes 504, 506 is maintained. For example, the bodies 530 can have widths such that, when disposed between the sets of electrodes 504, 506, can maintain a distance between the sets of electrodes 504, 506 in a range of no more than 8-12 mm. Any other distance is contemplated and may be achieved by changing the widths of respective ones of the bodies 530.

To further facilitate the assembly of the excimer lamp system 500, the plate 526 (identified by BOTTOM PLATE) can be attached to other component(s) of the excimer lamp system 500. For example, the plate 526 can be drilled (e.g., pre-drilled) with a plurality of holes through which one(s) of the fasteners 528 can be inserted (for attachment to other component(s)). The fasteners 528 of this example are screws but any other type of fastener is contemplated such as a bolt. In the illustrated example, the components of the excimer lamp system 500 can be assembled together such that the lamps 502 and the electrodes 504, 506 are disposed within a housing. For example, the cover 518 and the plate 526, when assembled together along with other component(s) shown in FIG. 5, can form a housing to include the lamps 502 and the electrodes 504, 506.

In the illustrated example, the lamp supports 510, 512, the side supports 520, 522, the insulators 524, and the plate 526 are constructed from insulator(s), such as highly insulating material(s), to avoid and/or reduce electrical losses. Non-limiting examples of highly insulating material(s) include Teflon, plastics, and ceramics (e.g., ceramic materials). Any other type of highly-insulating material is contemplated.

To facilitate electrical connections to the excimer lamp system 500, an electrical connection system 532 is provided. The electrical connection system 532 includes an electrical connector 534 and a plurality of wires 536. The electrical connector 534 and the plurality of wires 536 are adapted for high-voltage electrical connections. For example, the electrical connector 534 is a high-voltage electrical connector such that it can be coupled to voltage sources up to 5 kV, 10 kV, etc. Furthering the example, the plurality of wires 536 can be high-voltage wires adapted to be coupled to voltage sources up to 5 kV, 10 kV, etc. The electrical connector 534 of this example is an electrical plug with electrical terminals (e.g., pins) but in other embodiments may be an electrical receptacle with electrical sockets.

The electrical connector 534 of this example can be configured to be coupled to one or more power supplies such that the one or more power supplies can output a voltage and a current to the lamps 502 via the electrodes 504, 506 and the wires 536. For example, two of the wires 536 can be coupled to the one or more power supplies via the electrical connector 534. The remaining four wires 536 can be coupled to the plurality of electrodes 504, 506 in a push-pull configuration. For example, two of the four wires 536 can be coupled to the first set of electrodes 504 and the remaining two of the four wires 536 can be coupled to the second set of electrodes 506. In the illustrated example, the wires 536 can be attached to the electrodes 504, 506 and/or, more generally, the excimer lamp system 500, via ones of the fasteners 528. Alternatively, one(s) of the wires 536 may be soldered or welded to corresponding one(s) of the electrodes 504, 506.

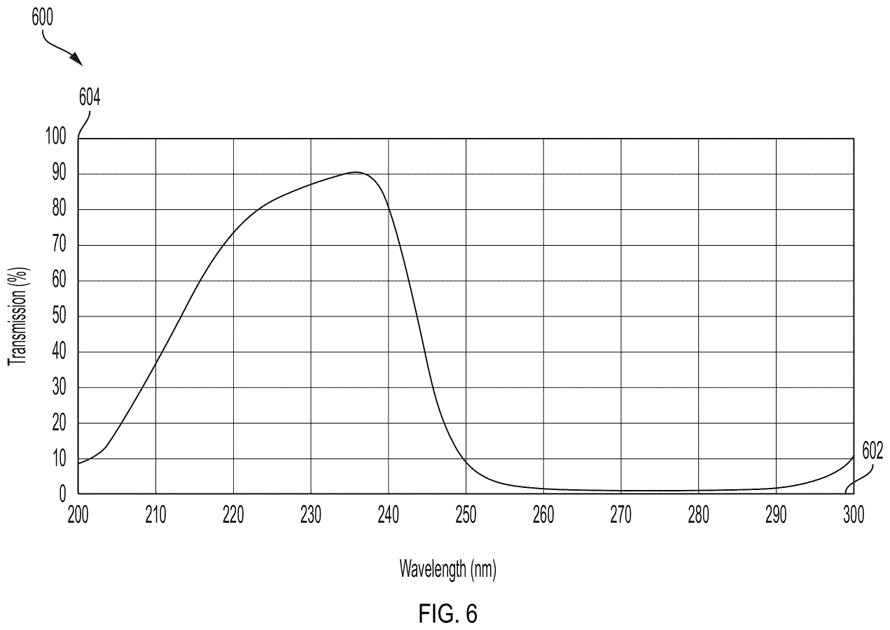

FIG. 6 shows a plot 600 of transmission with respect to wavelength for a tested piece of quartz doped with cerium oxide, without titanium oxide. For example, the plot 600 can represent the transmission of UV light through the tubes 402 of FIGS. 4A and/or 4B, with respect to wavelength, when a portion of an envelope of the tubes 402 is constructed of quartz doped with cerium oxide, without titanium oxide. By way of another example, the plot 600 can represent the transmission of UV light through the lamps 502 of FIG. 5, with respect to wavelength, when a portion of an envelope of the lamps 502 is constructed of quartz doped with cerium oxide. The plot 600 has an x-axis 602 representing a wavelength of UV light in nm. The plot 600 has a y-axis 604 representing a transmission in percentage. As can be seen, the transmission falls off significantly for longer wavelengths.

By way of example and illustrated by the plot 600, a portion of the envelope of the tubes 402 of FIGS. 4A and/or 4B can have a transmission of at least 50% of light having a wavelength of 222 nm. By way of another example and illustrated by the plot 600, the portion of the envelope of the tubes 402 of FIGS. 4A and/or 4B can have a transmission of at least 70% of light having a wavelength of 222 nm. By way of yet another example and illustrated by the plot 600, the portion of the envelope of the tubes 402 of FIGS. 4A and/or 4B can have a transmission of no more than 20% for light having a wavelength between 250 nm and 280 nm. By way of yet another example and illustrated by the plot 600, the portion of the envelope of the tubes 402 of FIGS. 4A and/or 4B can have a transmission of no more than 10% for light having a wavelength between 250 nm and 280 nm.

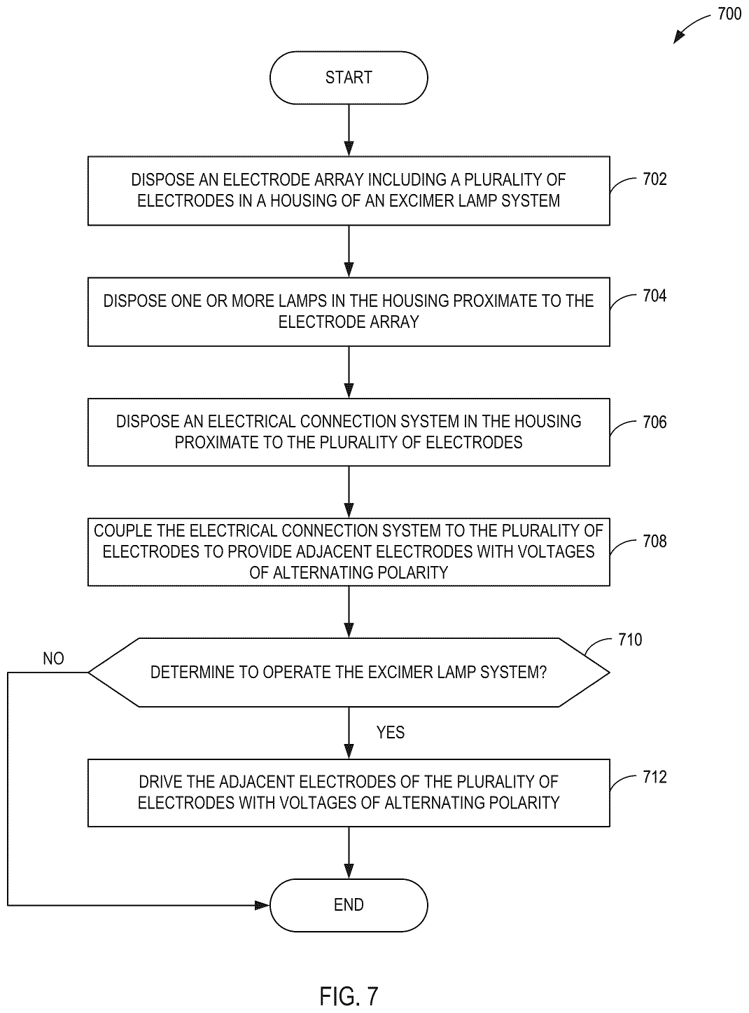

FIG. 7 is a flowchart 700 representative of an example process that may be performed and/or implemented to manufacture, calibrate, test, and/or operate an excimer lamp, such as one(s) of the excimer lamps 100, 200, 300, 400 of FIGS. 1, 2, 3, 4A, and/or 4B, and/or an excimer lamp system, such as the excimer lamp system 500 of FIG. 5. The flowchart 700 of FIG. 7 begins at block 702, at which an electrode array including a plurality of electrodes is disposed in a housing of an excimer lamp system. For example, one or more users (e.g., an excimer lamp manufacturer, a technician, an assembly worker, an assembly robot, a collaborative robot, etc.) may place and/or install the plurality of electrodes 504, 506 of FIG. 5 on the insulators 524 for eventual encapsulation within a housing formed by components of the excimer lamp system 500 of FIG. 5, such as at least the plate 526 and the cover 518.

At block 704, one or more lamps are disposed in the housing proximate to the electrode array. For example, one or more users may attach the lamps 502 of FIG. 5 to the electrodes 504, 506 for eventual encapsulation within the housing.

At block 706, an electrical connection system is disposed in the housing proximate to the plurality of electrodes. For example, one or more users may place the electrical connection system 532, or portion(s) thereof, such as one(s) of the wires 536, for attachment to the electrodes 504, 506 for eventual encapsulation by the housing.

At block 708, the electrical connection system is coupled to the plurality of electrodes to provide adjacent electrodes with voltages of alternating polarity. For example, one or more users may establish electrical connections between the wires 536 and corresponding ones of the electrodes 504, 506 such that, when one or more power supplies to be coupled to the wires 536 are powered on, provide adjacent ones of the electrodes 504, 506 with voltages of alternating polarity.

At block 710, it is determined whether to operate the excimer lamp system. For example, one or more users may determine to calibrate the excimer lamp system 500 such as by providing power to the excimer lamp system 500, measuring electrical and/or thermal characteristics of the excimer lamp system 500, and/or making adjustments to component(s) of the excimer lamp system 500 response to the measurements. In another example, one or more users may determine to test the excimer lamp system 500 to determine that operation thereof is within satisfactory and/or expected operating limits (e.g., current, voltage, and/or power draws, ambient temperature rise, UV light emission efficiency, TLVs). In yet another example, one or more users may determine to operate the excimer lamp system 500 to sterilize an area. In another example, one or more users may determine to operate the excimer lamp system 500 for air purification, air disinfection, and/or water disinfection.

If, at block 710, it is not determined to operate the excimer lamp system, the flowchart 700 concludes. For example, the excimer lamp system 500 may be packaged for transportation and/or delivery to a customer, prepared for sale, etc., and/or any combination(s) thereof. If, at block 710, it is determined to operate the excimer lamp system, control proceeds to block 712.

At block 712, one or more users drive the adjacent electrodes of the plurality of electrodes with voltages of alternating polarity. For example, the electrical connector 534 may be coupled to a power source, such as one or more power supplies or an AC power source such as an electrical wall outlet. After coupling the electrical connector 534 to the power source, one or more users may turn on and/or otherwise enable the power source to provide power to the excimer lamp system 500 such that adjacent ones of the plurality of electrodes 504, 506 are driven with voltages of alternating polarity. After driving the electrodes at block 712, the flowchart 700 of FIG. 7 concludes.

Techniques operating according to the principles described herein may be implemented in any suitable manner. For example, the flowchart 700 of FIG. 7 illustrates the functional information and/or operations one skilled in the art may use to fabricate, manufacture, calibrate, test, and/or operate an excimer lamp.

It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items. The use of “coupled” or “connected” is meant to refer to circuit elements, or signals, that are either directly linked to one another or through intermediate components.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

The terms “approximately”, “substantially,” and “about” may be used to mean within ±20% of a target value in some embodiments, within ±10% of a target value in some embodiments, within ±5% of a target value in some embodiments, and within ±2% of a target value in some embodiments. The terms “approximately” and “about” may include the target value.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:

1. An excimer lamp comprising: a dielectric forming at least one side of a sealed cavity; an electrode array disposed over a surface of the dielectric, the electrode array comprising a plurality of electrodes of alternating polarity disposed at respective positions across at least one dimension of the excimer lamp; and a gas within the sealed cavity, the gas being capable of emitting ultraviolet light in response to excitation of the electrode array.

2. The excimer lamp of aspect 1, wherein the dielectric is a glass, quartz, sapphire, or ceramic material.

3. The excimer lamp of any of aspects 1-2, wherein the dielectric has a flat surface or a curved surface.

4. The excimer lamp of any of aspects 1-3, wherein the dielectric has a flat surface.

5. The excimer lamp of any of aspects 1-4, further comprising drive circuitry for driving the plurality of electrodes.

6. The excimer lamp of any of aspects 1-5, wherein the drive circuitry is configured to provide a voltage to the plurality of electrodes in a range up to 10 kilovolts.

7. The excimer lamp of any of aspects 1-6, further comprising a connector configured to provide the voltage from a power supply to the plurality of electrodes in the range up to 10 kilovolts.

8. The excimer lamp of any of aspects 1-7, wherein the electrode array is a two-dimensional array of electrodes.

9. The excimer lamp of any of aspects 1-8, wherein the at least one dimension comprises a first dimension and a second dimension, and a polarity of the electrodes alternates along both the first dimension and the second dimension.

10. The excimer lamp of any of aspects 1-9, wherein the electrode array has a stripe pattern.

11. The excimer lamp of any of aspects 1-10, wherein the electrode array has a checkerboard pattern.

12. The excimer lamp of any of aspects 1-11, wherein a tube comprising the dielectric forms the sealed cavity.

13. The excimer lamp of any of aspects 1-12, wherein the tube is a cylindrical tube, a helical tube, or a square tube.

14. The excimer lamp of any of aspects 1-13, wherein the tube is a cylindrical tube.

15. The excimer lamp of any of aspects 1-14, wherein at least some of the plurality of electrodes are disposed on a curved side of the tube.

16. The excimer lamp of any of aspects 1-15, wherein each of the plurality of electrodes extends around a portion of a circumference of the tube.

17. The excimer lamp of any of aspects 1-16, further comprising: a second tube comprising a second dielectric forming a second sealed cavity; a second electrode array disposed over a surface of the second dielectric, the second electrode array comprising a second plurality of electrodes of alternating polarity disposed at respective positions across at least one dimension of the excimer lamp; and a gas within the second sealed cavity capable of emitting ultraviolet light in response to excitation of the second electrode array.

18. The excimer lamp of any of aspects 1-17, wherein adjacent electrodes of the plurality of electrodes are spaced apart by a distance of no more than a distance in a range of 8 to 12 millimeters.

19. The excimer lamp of any of aspects 1-18, wherein the ultraviolet light has a peak wavelength between 200 and 230 nanometers.

20. The excimer lamp of any of aspects 1-19, having a rigid construction.

21. The excimer lamp of any of aspects 1-20, having a flexible construction.

22. The excimer lamp of any of aspects 1-21, further comprising a window through which the ultraviolet light is emitted.

23. The excimer lamp of any of aspects 1-22, wherein the window is a quartz or sapphire material.

24. The excimer lamp of any of aspects 1-23, wherein the window is a doped material constructed to prevent the ultraviolet light having a peak wavelength greater than 230 nanometers from being emitted.

25. The excimer lamp of any of aspects 1-24, wherein the sealed cavity comprises a doped surface constructed to prevent the ultraviolet light having a peak wavelength greater than 230 nanometers from being emitted.

26. The excimer lamp of any of aspects 1-25, wherein the excimer lamp does not comprise a window.

27. The excimer lamp of any of aspects 1-26, wherein the electrode array comprises a first electrode and a second electrode, wherein the first electrode is closer to an edge of the sealed cavity than the second electrode, and wherein the first electrode has a width smaller than that of the second electrode in a direction perpendicular to the edge.

28. The excimer lamp of any of aspects 1-27, wherein the at least one side comprises a first side and a second side opposite the first side, and the electrode array comprises a first electrode disposed on the first side and a second electrode disposed on the second side.

29. The excimer lamp of any of aspects 1-28, wherein the ultraviolet light is emitted through a portion of the sealed cavity between the first side and the second side.

30. The excimer lamp of any of aspects 1-29, wherein the ultraviolet light is emitted through a plurality of excimer plasma discharges.

31. The excimer lamp of any of aspects 1-30, wherein each of the plurality of electrodes comprises at least one channel to removably receive the sealed cavity.

32. An excimer lamp system, comprising: a lamp comprising a dielectric forming at least one side of a sealed cavity; an electrode array disposed over a surface of the dielectric, the electrode array comprising a plurality of electrodes of alternating polarity disposed at respective positions across at least one dimension of the lamp; a window; and a gas within the scaled cavity, the gas being capable of emitting ultraviolet light through the window in response to excitation of the electrode array.

33. The excimer lamp system of aspect 32, further comprising a cover attached to the window to form a housing of the excimer lamp system.

34. The excimer lamp system of any of aspects 32-33, further comprising lamp support structures attached to the sealed cavity.

35. The excimer lamp system of any of aspects 32-34, further comprising a gasket attached to the window and the lamp support structures.

36. The excimer lamp system of any of aspects 32-35, wherein the gasket is resistant to ultraviolet light.

37. The excimer lamp system of any of aspects 32-36, further comprising one or more second lamps respectively comprising a dielectric forming at least one side of a sealed cavity.

38. The excimer lamp system of any of aspects 32-37, wherein the window is a doped material constructed to prevent the ultraviolet light having a peak wavelength greater than 230 nanometers from being emitted.

39. The excimer lamp system of any of aspects 32-38, wherein the sealed cavity comprises a doped surface constructed to prevent the ultraviolet light having a peak wavelength greater than 230 nanometers from being emitted.

40. A method of operating an excimer lamp comprising a dielectric forming at least one side of a sealed cavity and an electrode array disposed over a surface of the dielectric, the electrode array comprising a plurality of electrodes disposed at respective positions across at least one dimension of the excimer lamp, the excimer lamp further comprising a gas within the sealed cavity, the gas being capable of emitting ultraviolet light in response to excitation of the electrode array, the method comprising: driving adjacent electrodes of the plurality of electrodes with voltages of alternating polarity.

41. The method of aspect 40, wherein excitation of the electrode array comprises driving the adjacent electrodes with the voltages of alternating polarity.

42. The method of any of aspects 40-41, further comprising controlling one or more power supplies to provide the voltages of alternating polarity.

43. An excimer lamp, comprising: a dielectric forming at least one side of a sealed cavity; an electrode array disposed over a surface of the dielectric, the electrode array comprising a plurality of electrodes of alternating polarity disposed at respective positions across at least one dimension of the lamp; and a gas within the sealed cavity, the gas being capable of emitting the ultraviolet light in response to excitation of the electrode array.

44. The excimer lamp of aspect 43, further comprising drive circuitry for driving the electrode array.

45. The excimer lamp of any of aspects 43-44, wherein the dielectric has a flat surface or a curved surface.

46. The excimer lamp of any of aspects 43-45, wherein the dielectric has a flat surface.

47. The excimer lamp of any of aspects 43-46, wherein the plurality of electrodes is a two-dimensional array of electrodes.

48. The excimer lamp of any of aspects 43-47, wherein a polarity of the electrodes alternates along both a first dimension and a second dimension.

49. The excimer lamp of any of aspects 43-48, wherein the plurality of electrodes has a checkerboard pattern.

50. The excimer lamp of any of aspects 43-49, wherein the plurality of electrodes has a stripe pattern.

51. The excimer lamp of any of aspects 43-50, wherein a tube comprising the dielectric forms the sealed cavity.

52. The excimer lamp of any of aspects 43-51, wherein the plurality of electrodes are disposed on a curved side of the tube.

53. The excimer lamp of any of aspects 43-52, wherein each of the plurality of electrodes extends around a portion of a circumference of the tube.

54. The excimer lamp of any of aspects 43-53, further comprising: a second tube comprising a second dielectric forming a second sealed cavity; a second electrode array disposed over a surface of the dielectric, the second electrode array comprising a second plurality of electrodes of alternating polarity disposed at respective positions across at least one dimension of the excimer lamp; and a gas within the second sealed cavity capable of emitting the ultraviolet light in response to excitation of the second electrode array.

55. The excimer lamp of any of aspects 43-54, wherein adjacent electrodes of the plurality of electrodes are spaced apart by a distance of no more than 8-12 mm.

56. The excimer lamp of any of aspects 43-55, wherein the ultraviolet light has a peak wavelength between 200 and 230 nm.

57. The excimer lamp of any of aspects 43-56, having a rigid construction.

58. The excimer lamp of any of aspects 43-57, having a flexible construction.

59. The excimer lamp of any of aspects 43-58, wherein the plurality of electrodes comprises a first electrode and a second electrode, wherein the first electrode is closer to an edge of the sealed cavity than the second electrode, and wherein the first electrode has a width smaller than that of the second electrode in a direction perpendicular to the edge.

60. A method of operating an excimer lamp comprising a dielectric forming at least one side of a sealed cavity and an electrode array disposed over a surface of the dielectric, the electrode array comprising a plurality of electrodes disposed at respective positions across at least one dimension of the lamp, the excimer lamp further comprising a gas within the scaled cavity, the gas being capable of emitting the ultraviolet light in response to excitation of the electrode array, the method comprising: driving adjacent electrodes of the plurality of electrodes with voltages of alternating polarity.

1. An excimer lamp, comprising:
a dielectric forming at least one side of a sealed cavity;
an electrode array disposed over a surface of the dielectric, the electrode array comprising a plurality of electrodes of alternating polarity disposed at respective positions across at least one dimension of the excimer lamp; and
a gas within the sealed cavity, the gas being capable of emitting ultraviolet light in response to excitation of the electrode array.

2. The excimer lamp of claim 1, wherein the dielectric is a glass, quartz, sapphire, or ceramic material.

3. The excimer lamp of claim 1, wherein the dielectric has a flat surface or a curved surface.

4. (canceled)

5. The excimer lamp of claim 1, further comprising drive circuitry for driving the plurality of electrodes.

6-8. (canceled)

9. The excimer lamp of claim 1, wherein the electrode array is a two-dimensional array of electrodes, at least one dimension comprises a first dimension and a second dimension, and a polarity of the electrodes alternates along both the first dimension and the second dimension.

10. The excimer lamp of claim 1, wherein the electrode array has a stripe pattern.

11. The excimer lamp of claim 1, wherein the electrode array has a checkerboard pattern.

12. (canceled)

13. The excimer lamp of claim 1, wherein a tube comprising the dielectric forms the sealed cavity, and the tube is a cylindrical tube, a helical tube, or a square tube.

14. (canceled)

15. The excimer lamp of claim 13, wherein at least some of the plurality of electrodes are disposed on a curved side of the tube.

16. The excimer lamp of claim 15, wherein each of the plurality of electrodes extends around a portion of a circumference of the tube.

17. The excimer lamp of claim 13, further comprising:
a second tube comprising a second dielectric forming a second sealed cavity;
a second electrode array disposed over a surface of the second dielectric, the second electrode array comprising a second plurality of electrodes of alternating polarity disposed at respective positions across at least one dimension of the excimer lamp; and
a gas within the second sealed cavity capable of emitting ultraviolet light in response to excitation of the second electrode array.

18. The excimer lamp of claim 1, wherein adjacent electrodes of the plurality of electrodes are spaced apart by a distance of no more than a distance in a range of 8 to 12 millimeters.

19-26. (canceled)

27. The excimer lamp of claim 1, wherein the electrode array comprises a first electrode and a second electrode, wherein the first electrode is closer to an edge of the sealed cavity than the second electrode, and wherein the first electrode has a width smaller than that of the second electrode in a direction perpendicular to the edge.

28-31. (canceled)

32. An excimer lamp system, comprising:
a lamp comprising a dielectric forming at least one side of a sealed cavity;
an electrode array disposed over a surface of the dielectric, the electrode array comprising a plurality of electrodes of alternating polarity disposed at respective positions across at least one dimension of the lamp;
a window; and
a gas within the sealed cavity, the gas being capable of emitting ultraviolet light through the window in response to excitation of the electrode array.

33. The excimer lamp system of claim 32, further comprising a cover attached to the window to form a housing of the excimer lamp system.

34. The excimer lamp system of claim 32, further comprising lamp support structures attached to the sealed cavity.

35. The excimer lamp system of claim 34, further comprising a gasket attached to the window and the lamp support structures.

36. The excimer lamp system of claim 35, wherein the gasket is resistant to ultraviolet light.

37-39. (canceled)

40. A method of operating an excimer lamp comprising a dielectric forming at least one side of a sealed cavity and an electrode array disposed over a surface of the dielectric, the electrode array comprising a plurality of electrodes disposed at respective positions across at least one dimension of the excimer lamp, the excimer lamp further comprising a gas within the sealed cavity, the gas being capable of emitting ultraviolet light in response to excitation of the electrode array, the method comprising:
driving adjacent electrodes of the plurality of electrodes with voltages of alternating polarity.

41. The method of claim 40, wherein excitation of the electrode array comprises driving the adjacent electrodes with the voltages of alternating polarity.

42-60. (canceled)
